(19) United States
(12) Patent Application Publication
(10) Pub. No.: US 2024/0419570 A1
(43) Pub. Date: Dec. 19, 2024

(54) STORAGE SYSTEM MANAGEMENT METHOD AND APPARATUS, AND DEVICE AND READABLE STORAGE MEDIUM

(71) Applicant: INSPUR SUZHOU INTELLIGENT TECHNOLOGY CO., LTD., Suzhou, Jiangsu (CN)

(72) Inventor: Liqun YANG, Suzhou, Jiangsu (CN)

(21) Appl. No.: 18/725,099

(22) PCT Filed: Nov. 23, 2022
(86) PCT No.: PCT/CN2022/133826

§ 371 Date: Jun. 27, 2024

(30) Foreign Application Priority Data
Apr. 8, 2022 (CN) 202210362954.1

(51) Int. Cl. G06F 11/30; G06F 11/32

(52) U.S. Cl. CPC G06F 11/3034; G06F 11/3072; G06F 11/327

(57) ABSTRACT

The present disclosure discloses a method and an apparatus for managing a storage system. The method includes: determining an original resource model of any target object in an original storage system, wherein the target object includes one or more application processes, one or more virtual machine kernels, and/or one or more file storage services in the original storage system; determining a front-end service type corresponding to the original storage system, and querying a target resource model with an attribute of the front-end service type and the greatest similarity with the original resource model in an available model library corresponding to the target object; and determining a software/hardware resource update strategy of the target object by comparing the original resource model with the target resource model, and updating the original storage system and/or deploying a new storage system including the target object based on the software/hardware resource update strategy.

### CROSS-REFERENCE TO RELATED APPLICATION

The present disclosure claims the priority of Chinese patent application filed on Apr. 8, 2022 before the CNIPA, China National Intellectual Property Administration with the application number of 202210362954.1, and the title of “STORAGE SYSTEM MANAGEMENT METHOD AND APPARATUS, DEVICE, AND READABLE STORAGE MEDIUM”, which is incorporated herein in its entirety by reference.

### FIELD

The present disclosure relates to the field of computer technologies, and more particularly to a method for managing a storage system, an apparatus for managing a storage system, an electronic device, and a non-transitory computer-readable storage medium.

### BACKGROUND

At present, after deploying a back-end storage system for an enterprise business system, the storage system may not be able to match front-end services. For example, service traffic increases sharply under a certain operation, and a port of the storage system deployed currently cannot bear the service traffic increased sharply, resulting in a failure of the back-end storage system. Moreover, when the failure occurs, it is necessary to spend a lot of costs to locate and analyze, which will affect the front-end services.

### SUMMARY

In view of this, an object of the present disclosure is to provide a method for managing a storage system, an apparatus for managing a storage system, an electronic device, and a non-transitory computer-readable storage medium, so as to make a back-end storage system suitable for front-end services. Solutions are as follows.

Based on the above object, in an aspect, the present disclosure provides a method for managing a storage system, including:
determining an original resource model of any target object in an original storage system, wherein the target object includes one or more application processes, one or more virtual machine kernels, and/or one or more file storage services in the original storage system;
determining a front-end service type corresponding to the original storage system, and querying a target resource model with an attribute of the front-end service type and the greatest similarity with the original resource model in an available model library corresponding to the target object; and
determining a software/hardware resource update strategy of the target object by comparing the original resource model with the target resource model, and updating the original storage system and/or deploying a new storage system including the target object based on the software/hardware resource update strategy.

In some embodiments, determining the original resource model of any target object in the original storage system includes:
obtaining resource occupation information of the target object in the original storage system within a period of time; and
in response to the resource occupation information not including information triggering a system early warning, querying service operation data corresponding to the resource occupation information in a system log, and constructing the original resource model based on the resource occupation information and the service operation data.

In some embodiments, the resource occupation information includes: central processing unit (CPU) occupation information, disk read/write information, input/output (IO) delay information and/or memory occupation information.

In some embodiments, obtaining the resource occupation information of the target object on the original storage system within the period of time includes:
in response to the resource occupation information at any moment exceeding a preset value, recording the resource occupation information at a current moment; in response to the resource occupation information at any moment not exceeding the preset value, not recording the resource occupation information at the current moment and starting a countdown at the same time; and
in response to the resource occupation information exceeding the preset value before the countdown ends, forcibly ending the countdown and recording the resource occupation information exceeding the preset value at the same time; and in response to the resource occupation information never exceeding the preset value during the countdown, summarizing all recorded resource occupation information to obtain the resource occupation information within the period of time.

In some embodiments, the method further includes:
in response to the resource occupation information including the information triggering the system early warning, dividing the resource occupation information into alarm information triggering the system early warning and non-alarm information not triggering the system early warning;
querying service operation data corresponding to the alarm information in the system log, and generating an alarm report based on the alarm information and the service operation data; and
querying service operation data corresponding to the non-alarm information in the system log, and constructing the original resource model based on the non-alarm information and the service operation data.

In some embodiments, determining the software/hardware resource update strategy of the target object by comparing the original resource model with the target resource model includes:
comparing the original resource model with the target resource model to obtain a comparison result; and
determining a software/hardware configuration to be updated for the target object based on the comparison result, and obtaining the software/hardware resource update strategy based on the software/hardware configuration.

In some embodiments, the method further includes:
determining an original service traffic model corresponding to the original resource model;
determining a target service traffic model corresponding to the target resource model; and
comprehensively determining the software/hardware resource update strategy by comparing the original resource model with the target resource model and comparing the original service traffic model with the target service traffic model.

In another aspect, the present disclosure provides an apparatus for managing a storage system, including:
a determining module configured to determine an original resource model of any target object in an original storage system, wherein the target object includes one or more application processes, one or more virtual machine kernels, and/or one or more file storage services in the original storage system;
a comparing module configured to determine a front-end service type corresponding to the original storage system, and query a target resource model with an attribute of the front-end service type and the greatest similarity with the original resource model in an available model library corresponding to the target object; and
an updating module configured to determine a software/hardware resource update strategy of the target object by comparing the original resource model with the target resource model, and update the original storage system and/or deploying a new storage system including the target object based on the software/hardware resource update strategy.

In yet another aspect, the present disclosure provides an electronic device, including:
a memory for storing a computer program; and
a processor for executing the computer program to implement the following operations;
determining an original resource model of any target object in an original storage system, wherein the target object includes one or more application processes, one or more virtual machine kernels, and/or one or more file storage services in the original storage system;
determining a front-end service type corresponding to the original storage system, and querying a target resource model with an attribute of the front-end service type and the greatest similarity with the original resource model in an available model library corresponding to the target object; and
determining a software/hardware resource update strategy of the target object by comparing the original resource model with the target resource model, and updating the original storage system and/or deploying a new storage system including the target object based on the software/hardware resource update strategy.

In still another aspect, the present disclosure provides a non-transitory computer-readable storage medium storing computer programs, wherein the computer programs, when executed by a processor, cause the processor to implement the following operations:
determining an original resource model of any target object in an original storage system, wherein the target object includes one or more application processes, one or more virtual machine kernels, and/or one or more file storage services in the original storage system;
determining a front-end service type corresponding to the original storage system, and querying a target resource model with an attribute of the front-end service type and the greatest similarity with the original resource model in an available model library corresponding to the target object; and
determining a software/hardware resource update strategy of the target object by comparing the original resource model with the target resource model, and updating the original storage system and/or deploying a new storage system including the target object based on the software/hardware resource update strategy.

Based on the above solutions, the present disclosure provides a method for managing a storage system, including: determining an original resource model of any target object in an original storage system, wherein the target object includes one or more application processes, one or more virtual machine kernels, and/or one or more file storage services in the original storage system; determining a front-end service type corresponding to the original storage system, and querying a target resource model with an attribute of the front-end service type and the greatest similarity with the original resource model in an available model library corresponding to the target object; and determining a software/hardware resource update strategy of the target object by comparing the original resource model with the target resource model, and updating the original storage system and/or deploying a new storage system including the target object based on the software/hardware resource update strategy.

It may be seen that in the present disclosure, the original resource model corresponding to any application process, any virtual machine kernel, and/or any file storage service in the storage system may be determined, and then the target resource model with the attribute of the front-end service type and the greatest similarity with the original resource model may be queried in a corresponding available model library. Further, the software/hardware resource update strategy of the target object may be determined by comparing the original resource model with the target resource model, and then the original storage system may be updated and/or the new storage system including the target object may be deployed based on the software/hardware resource update strategy. It may be seen that in this solution, for any target object in a storage system, another resource model which is most similar to the current resource model of the target object and has the same service type attribute may be found in the model library, and then resources required to be updated for the target object may be determined by comparing the two models; further, the software/hardware resource update strategy may be obtained, and the original storage system may be updated and/or the new storage system including the target object may be deployed. That is, the solution may quickly locate and update the weak configuration of the original storage system with reference to the model in the model library, and may also quickly deploy the new storage system suitable for the front-end service type and capable of coping with sudden service conditions.

The present disclosure further provides an apparatus for managing a storage system, an electronic device, and a non-transitory computer-readable storage medium, which have the above technical effects.

### BRIEF DESCRIPTION OF THE DRAWINGS

In order to more clearly illustrate the technical solutions of some embodiments of the present disclosure or the prior art, the figures that are required to describe some embodiments of the present disclosure or the prior art will be briefly described below. Apparently, the figures that are described below are merely some embodiments of the present disclosure, and a person skilled in the art can obtain other figures according to the provided figures without paying creative work.

FIG. 1 is a flowchart of a method for managing a storage system according to the present disclosure;

FIG. 2 is a comparative schematic diagram of a traffic module according to the present disclosure:

FIG. 3 is a schematic diagram of an apparatus for managing a storage system according to the present disclosure:

FIG. 4 is a schematic diagram of an electronic device according to the present disclosure; and

FIG. 5 is a schematic diagram of a non-transitory computer-readable storage medium according to the present disclosure.

### DETAILED DESCRIPTION

The following clearly and completely describes the technical solutions in some embodiments of the present disclosure with reference to the accompanying drawings in some embodiments of the present disclosure. Apparently, the described embodiments are merely certain embodiments of the present disclosure, rather than all of the embodiments. All of the other embodiments that a person skilled in the art obtains based on the embodiments of the present disclosure without paying creative work fall within the protection scope of the present disclosure.

At present, after deploying a back-end storage system for an enterprise business system, the storage system may not be able to match front-end services. For example, service traffic increases sharply under a certain operation, and a port of the storage system deployed currently cannot bear the service traffic increased sharply, resulting in a failure of the back-end storage system. Moreover, when the failure occurs, it is necessary to spend a lot of costs to locate and analyze, which will affect the front-end services. To this end, the present disclosure provides a method for managing a storage system, which may quickly locate and update the weak configuration of the original storage system with reference to the model in the model library, and may also quickly deploy the new storage system suitable for the front-end service type and capable of coping with sudden service conditions, so as to make a back-end storage system suitable for front-end services.

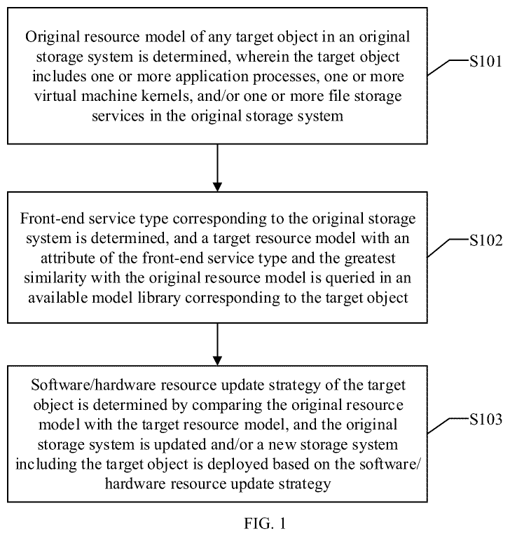

Referring to FIG. 1, some embodiments of the present disclosure disclose a method for managing a storage system, including the following steps.

S101, an original resource model of any target object in an original storage system is determined, wherein the target object includes one or more application processes, one or more virtual machine kernels, and/or one or more file storage services in the original storage system.

In some embodiments, determining the original resource model of any target object in the original storage system includes: obtaining resource occupation information of the target object in the original storage system within a period of time; and in response to the resource occupation information not including information triggering a system early warning, querying service operation data corresponding to the resource occupation information in a system log, and constructing the original resource model based on the resource occupation information and the service operation data. It may be seen that the original resource model of the target object is constructed based on the resource occupation information of the target object in the original storage system and the corresponding service operation data. The service operation data is a reason for the appearance of the corresponding resource occupation information, that is, one or more service operations will trigger resource occupation.

The resource occupation information that will not triggering the system early warning indicates that a resource occupation condition of the target object on the original storage system meets one or more operation requirements of the storage system, and since the resource occupation is triggered by the service operations, it indicates that such service operation data meets the operation requirements of the storage system. It may be seen that the resource occupation information and the service operation data used to construct the original resource model of the target object meet the operation requirements of the storage system, and can represent a normal operation of the target object, and thus the original resource model meet the operation requirements of the storage system, and can represent a normal operation condition of the target object.

S102, a front-end service type corresponding to the original storage system is determined, and a target resource model with an attribute of the front-end service type and the greatest similarity with the original resource model is queried in an available model library corresponding to the target object.

Although the original resource model meets the operation requirements of the storage system and can represent the normal operation of the target object, since the service traffic increased sharply is an unpredictable problem, it is impossible to predict whether the current resource configuration of the original storage system can cope with abnormal situations such as service traffic burst. Since the problem is unpredictable, it is impossible to determine a solution for solving the problem. If the problem is solved until the problem appears, it will inevitably affect the front-end services.

In some embodiments of the present disclosure, an update solution of the storage system is determined before the problem occurs, and the storage system is updated. In order to determine a direction of updating the storage system, in the embodiment, the target resource model with the attribute of the front-end service type and the greatest similarity with the original resource model is queried in the available model library corresponding to the target object; and the software/hardware resource update strategy of the target object is determined by comparing the original resource model with the target resource model, therefore, the solution for solving the problem may be determined by referring to the target resource model, so that the storage system may be updated before the problem occurs, thereby reducing the probability of problems occurring in the storage system.

S103, a software/hardware resource update strategy of the target object is determined by comparing the original resource model with the target resource model, and the original storage system is updated and/or a new storage system including the target object is deployed based on the software/hardware resource update strategy.

In some embodiments, determining the software/hardware resource update strategy of the target object by comparing the original resource model with the target resource model includes: comparing the original resource model with the target resource model to obtain a comparison result; and determining a software/hardware configuration to be updated for the target object based on the comparison result, and obtaining the software/hardware resource update strategy based on the software/hardware configuration.

It should be noted that in some embodiments of the present disclosure, available model libraries corresponding to the application processes, the virtual machine kernels, and the file storage services respectively are pre-constructed, and each of the available model libraries stores one or more target resource models which are verified by experiments or practical applications and will not cause a sudden failure of the storage system or reduce the probability of the sudden failure of the storage system. Moreover, each of the target resource models in the available model library has a corresponding attribute. The attribute is the front-end service type such as an office service of office automation (OA), an e-commerce service, a financial service, or a customer service.

It may be seen that there are multiple available model libraries, which correspond to the application processes, the virtual machine kernels, and the file storage services respectively; and each available model library includes multiple target resource models, which correspond to the front-end service types such as the office service of OA, the e-commerce service, the financial service, the customer service, or the like. The process of constructing each target resource model can refer to the process of constructing the original resource model. It may be seen that the target resource model meets the operation requirements of the storage system and can represent the normal operation condition of the target object; and more importantly, the target resource model will not lead to the sudden failure of the storage system or can reduce the probability of the sudden failure of the storage system. Therefore, by determining the software/hardware resource update strategy with reference to the target resource model, and updating the original storage system and/or deploying the new storage system including the target object based on the software/hardware resource update strategy, it may be considered that the updated original storage system or the deployed new storage system has a relatively small sudden failure, and thus the storage system suitable for the front-end service type and capable of capable of coping with sudden service conditions may be obtained.

It may be seen that in some embodiments of the present disclosure, the original resource model corresponding to any application process, any virtual machine kernel, and/or any file storage service (for example, an operational services division (OSD) service, a common internet file system (CIFS) service, and the like) in the storage system may be determined, and then the target resource model with the attribute of the front-end service type and the greatest similarity with the original resource model may be queried in a corresponding available model library. Further, the software/hardware resource update strategy of the target object may be determined by comparing the original resource model with the target resource model, and then the original storage system may be updated and/or the new storage system including the target object may be deployed based on the software/hardware resource update strategy. It may be seen that in this solution, for any target object in a storage system, another resource model which is most similar to the current resource model of the target object and has the same service type attribute may be found in the model library, and then resources required to be updated for the target object may be determined by comparing the two models; further, the software/hardware resource update strategy may be obtained, and the original storage system may be updated and/or the new storage system including the target object may be deployed. That is, the solution may quickly locate and update the weak configuration of the original storage system with reference to the model in the model library, and may also quickly deploy the new storage system suitable for the front-end service type and capable of coping with sudden service conditions.

Based on the above embodiments, it should be noted that the resource occupation information includes: central processing unit (CPU) occupation information, disk read/write information, input/output (IO) delay information and/or memory occupation information.

When the target object is a virtual machine kernel, the CPU occupation information may be a ratio of CPU resources used by a corresponding virtual machine during running to physical CPU resources of a node. The node is a device node in a storage system (for example, a distributed storage system), and one or more virtual machines can be deployed in the device node. Accordingly, when the target object is an application process, the CPU occupation information may be a ratio of CPU resources used by a corresponding application process during running to the physical CPU resources of the node. It may be seen that when a target object is determined, all the CPU occupation information, the disk read/write information, the IO delay information and/or the memory occupation information correspond to the target object, that is, the occupation information generated when the target object runs.

If the CPU occupation information, the disk read/write information, the IO delay information and the memory occupation information are obtained for a target object, weighted summation can be performed on these information to obtain comprehensive information as the resource occupancy information of the target object. Alternatively, all these information can be directly used as the resource occupation information of the target object.

In some embodiments, obtaining the resource occupation information of the target object on the original storage system within the period of time includes: in response to the resource occupation information at any moment exceeding a preset value, recording the resource occupation information at a current moment; in response to the resource occupation information at any moment not exceeding the preset value, not recording the resource occupation information at the current moment and starting a countdown at the same time; and in response to the resource occupation information exceeding the preset value before the countdown ends, forcibly ending the countdown and recording the resource occupation information exceeding the preset value at the same time; and in response to the resource occupation information never exceeding the preset value during the countdown, summarizing all recorded resource occupation information to obtain the resource occupation information within the period of time.

The preset value can be set flexibly, for example, 10%. Theoretically, the preset value is an amount of resource information required for the storage system when it is self-starting operation. For example, assuming that the CPU occupation information (for example, a CPU occupancy rate) is 10% after basic software such as an operating system and an input/output system of the storage system starts running, the preset value can be 10%. When the CPU occupancy rate exceeds 10%, it indicates that one or more additional software application processes related to the service are running on the storage system. It may be seen that an application process, a virtual machine kernel and/or a file storage service as a monitored object have a strong correlation with the front-end services of the storage system. A TOP command and a SAR command can be used for monitoring.

A countdown time is 100 milliseconds (ms). Since an interval between different operations in the storage system is about 100 ms, if there is no burst data generated within 100 ms, it means that an operation is finished, and thus the countdown can be started when the resource occupation information is relatively small to distinguish different operations. Taking the countdown time of 100 ms as an example, assuming that resource occupation information X1 of an object exceeds a preset value at a time T1, the time T1 and corresponding X1 are recorded. If resource occupation information X1+1 of the object at a time T1+1 is less than the preset value. X1+1 will not be recorded and the countdown is started for 100 ms. If resource occupation information X1+6 exceeding the preset value occurs after the countdown starts for 5 ms (that is, at a time T1+6), the countdown ends, and the time T1+6 as well as corresponding X1+6 are recorded at the same time. If the resource occupation information exceeding the preset value never appears during the countdown, the final obtained resource occupation information within a period of time (that is. T1+100 ms) is: “time T1:X1” and a length of the period of time: T1+100 ms.

In some embodiments, the method further includes: in response to the resource occupation information including the information triggering the system early warning, dividing the resource occupation information into alarm information triggering the system early warning and non-alarm information not triggering the system early warning; querying service operation data corresponding to the alarm information in the system log, and generating an alarm report based on the alarm information and the service operation data; and querying service operation data corresponding to the non-alarm information in the system log, and constructing the original resource model based on the non-alarm information and the service operation data.

The appearance of information that will trigger the system early warning means that there is a threat to a stable operation of the system. For example, if an idle CPU occupation ratio of a node is less than 20%, it means that the CPU resources of the node are in resource shortage, and should be controlled to avoid further increase in the CPU occupation information. For another example, if the IO delay information (for example, an iowait value) is greater than 80, it is considered that the delay is relatively large and should be controlled to avoid further increase in the IO delay. Accordingly, a limit value of memory occupation information (for example, a kbbuffers value), a limit value of cache occupation information (for example, a kbcached value) and a limit value of disk read/write speed (for example, a % util value) can also be configured to ensure minimum information amounts required for the normal operation of the system.

Based on the above embodiments, it should be noted that the method further includes: determining an original service traffic model corresponding to the original resource model; determining a target service traffic model corresponding to the target resource model; and comprehensively determining the software/hardware resource update strategy by comparing the original resource model with the target resource model and comparing the original service traffic model with the target service traffic model.

The service traffic model can be determined according to the service traffic, and the representative traffic with self-similarity with the front-end services can be collected. The original storage system is a storage system being used by an original service party, or another storage system similar to the front-end services of a storage system being used by an original service party.

The service traffic can be collected by monitoring the traffic of each port of the storage system through a simple network management protocol (SNMP), and the traffic data can be visualized via a third-party software (for example, zabbix. Cacti, and the like). Hurst exponent can be used to determine whether the collected traffic has self-similarity, for example, traffic with the Hurst exponent H greater than 0.5 is selected to construct the service traffic model. Only when the Hurst exponent H is 0.5<H<1, it means positive correlation, that is, the collected traffic has self-similarity.

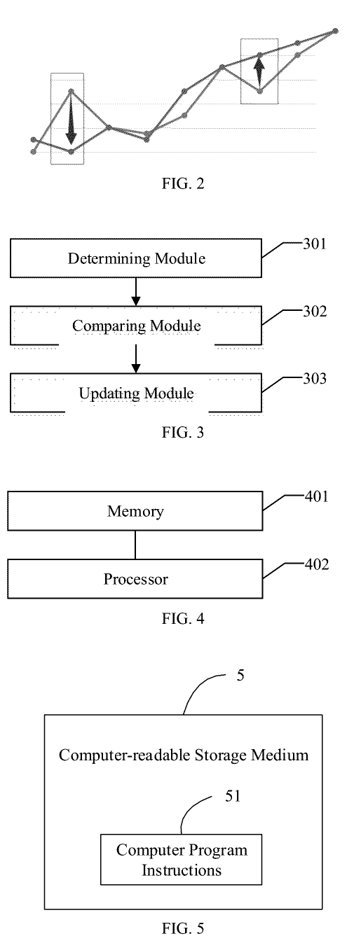

According to the above method, the original service traffic model and the target service traffic model can be determined, and then similarities and differences between the two traffic models are determined by an edit distance on real sequence (EDR). As shown in FIG. 2, a horizontal axis represents the time, a vertical axis represents a volume of the traffic, and curves represent the traffic of the two traffic models. If a value of the EDR value is relatively high, it indicates that traffic trajectories of the two traffic models are similar or the same; otherwise, it indicates that the traffic trajectories of the two traffic models are not similar.

As shown in FIG. 2, not every difference point needs to be analyzed, and only a larger traffic discrepancy point needs to be searched for analysis. The larger traffic discrepancy point has a high probability of causing the system problem, and thus an update strategy may be set for the point. For example, the traffic points at the boxes of FIG. 2. By analyzing the traffic discrepancy points and combining a comparison result between the original resource model and the target resource model, the software/hardware resource update strategy can be comprehensively determined. For example, the software/hardware resource update strategy can be adding hardware configurations such as cache and memory, or turning on a quality of service (QOS) service to limit the processing speed of non-instantaneous operations.

It may be seen that by analyzing the traffic discrepancy points and combining the comparison result of the original resource model and the target resource model, problems that may be encountered during the operation of the original storage system can be comprehensively determined, so that countermeasures can be prepared in advance to reduce the probability of system failures.

An apparatus for managing a storage system provided by some embodiments of the present disclosure is described below, and the apparatus for managing the storage system described below and the method for managing the storage system described above may be referred to each other.

Referring to FIG. 3, some embodiments of the present disclosure disclose an apparatus for managing a storage system, including:
a determining module 301 configured to determine an original resource model of any target object in an original storage system, wherein the target object includes one or more application processes, one or more virtual machine kernels, and/or one or more file storage services in the original storage system;
a comparing module 302 configured to determine a front-end service type corresponding to the original storage system, and query a target resource model with an attribute of the front-end service type and the greatest similarity with the original resource model in an available model library corresponding to the target object; and
an updating module 303 configured to determine a software/hardware resource update strategy of the target object by comparing the original resource model with the target resource model, and update the original storage system and/or deploying a new storage system including the target object based on the software/hardware resource update strategy.

In some embodiments, the determining module includes:
an obtaining unit configured to obtain resource occupation information of the target object in the original storage system within a period of time; and
a first constructing unit configured to in response to the resource occupation information not including information triggering a system early warning, query service operation data corresponding to the resource occupation information in a system log, and construct the original resource model based on the resource occupation information and the service operation data.

In some embodiments, the resource occupation information includes: central processing unit (CPU) occupation information, disk read/write information, input/output (IO) delay information and/or memory occupation information.

In some embodiments, the obtaining unit is configured to:
in response to the resource occupation information at any moment exceeding a preset value, record the resource occupation information at a current moment; in response to the resource occupation information at any moment not exceeding the preset value, not record the resource occupation information at the current moment and start a countdown at the same time; and
in response to the resource occupation information exceeding the preset value before the countdown ends, forcibly end the countdown and recording the resource occupation information exceeding the preset value at the same time; and in response to the resource occupation information never exceeding the preset value during the countdown, summarize all recorded resource occupation information to obtain the resource occupation information within the period of time.

In some embodiments, the determining module further includes:
a dividing unit configured to in response to the resource occupation information including the information triggering the system early warning, divide the resource occupation information into alarm information triggering the system early warning and non-alarm information not triggering the system early warning;
an alarming unit configured to query service operation data corresponding to the alarm information in the system log, and generate an alarm report based on the alarm information and the service operation data; and
a second constructing unit configured to query service operation data corresponding to the non-alarm information in the system log, and construct the original resource model based on the non-alarm information and the service operation data.

In some embodiments, the updating module is configured to:
compare the original resource model with the target resource model to obtain a comparison result; and
determine a software/hardware configuration to be updated for the target object based on the comparison result, and obtaining the software/hardware resource update strategy based on the software/hardware configuration.

In some embodiments, the apparatus further includes:
a traffic model comparing module configured to determine an original service traffic model corresponding to the original resource model; determine a target service traffic model corresponding to the target resource model; and comprehensively determine the software/hardware resource update strategy by comparing the original resource model with the target resource model and comparing the original service traffic model with the target service traffic model.

Here, with regard to the operation of each module and unit in the embodiment, reference may be made to the corresponding contents disclosed in the foregoing embodiments, and the description thereof will not be repeated.

It may be seen that some embodiments of the present disclosure provide an apparatus for managing a storage system which may quickly locate and update the weak configuration of the original storage system with reference to the model in the model library, and may also quickly deploy the new storage system suitable for the front-end service type and capable of coping with sudden service conditions.

An electronic device provided by some embodiments of the present disclosure is described below; and the electronic device described below and the method and apparatus for managing the storage system described above may be referred to each other.

Referring to FIG. 4, some embodiments of the present disclosure disclose an electronic device, including:
a memory 401 configured to store a computer program; and
a processor 402 configured to execute the computer program to implement the method for managing the storage system disclosed in the foregoing embodiments. With regard to the detailed steps of the method, reference may be made to corresponding contents in the foregoing embodiments, which will not be described in detail herein.

A non-transitory computer-readable storage medium provided by some embodiments of the present disclosure is described below, and the non-transitory computer-readable storage medium below and the method and apparatus for the storage system and the electronic device described above may be referred to each other.

Referring to FIG. 5, some embodiments of the present disclosure disclose a non-transitory computer-readable storage medium 5 storing computer programs 51, where the computer programs 51, when executed by a processor, cause the processor to implement the method for managing the storage system disclosed in the foregoing embodiments. With regard to the detailed steps of the method, reference may be made to corresponding contents in the foregoing embodiments, which will not be described in detail herein.

“First”. “second”. “third”. “fourth” and the like as used in the present disclosure are used to distinguish similar objects, and are not necessarily used to describe a specific order or sequence. It should be understood that the data expressed in this manner is interchangeable under appropriate circumstances such that the embodiments described herein can be practiced in sequences other than those illustrated or described herein. Furthermore, the terms “comprising” and “having”, as well as any variations thereof, are intended to cover a non-exclusive inclusion, e.g, a process, method or apparatus comprising a series of steps or elements is not necessarily limited to those steps or elements explicitly listed, but may include other steps or elements not explicitly listed or inherent to the process, method or apparatus.

It should be noted that the terms such as “first”. “second” are for descriptive purposes only, and should not be understood as indicating or implying their relative importance or implicitly indicating the number of indicated technical features. Thus, the features defined as “first” and “second” may explicitly or implicitly include at least one of these features. In addition, the technical solutions of the various embodiments can be combined with each other, but it must be based on the realization of those skilled in the art. When the combination of technical solutions is contradictory or cannot be realized, it should be considered that the combination of technical solutions does not exist, nor within the scope of protection required by the present disclosure.

Various embodiments in the specification are described in a progressive manner, each embodiment focuses on the difference from other embodiments, and the same and similar parts of various embodiments can be referred to each other.

The steps of the methods or algorithms described in connection with the embodiments disclosed herein may be directly implemented by hardware, software modules executed by a processor, or a combination of both. Software modules can be placed in random access memory (RAM), internal memory, read-only memory (ROM), electrically programmable ROM, electrically erasable programmable ROM, registers, hard disk, removable disk. CD-ROM, or any other non-transitory computer-readable storage medium known in the technical field.

Herein, specific examples are used to illustrate the principles and implementation methods of the present disclosure. The descriptions of the above embodiments are only used to help understand the method and core idea of the present disclosure; meanwhile, for those skilled in the art, there will be changes in the specific implementation and scope of the present disclosure based on the core idea of the present disclosure. In summary, the content of the specification should not be construed as limiting the present disclosure.

1. A method for managing a storage system, comprising:
determining an original resource model of any target object in an original storage system, wherein the target object comprises one or more application processes, one or more virtual machine kernels, and/or one or more file storage services in the original storage system;
determining a front-end service type corresponding to the original storage system, and querying a target resource model with an attribute of the front-end service type and the greatest similarity with the original resource model in an available model library corresponding to the target object; and
determining a software/hardware resource update strategy of the target object by comparing the original resource model with the target resource model, and updating the original storage system and/or deploying a new storage system comprising the target object based on the software/hardware resource update strategy.

2. The method according to claim 1, wherein determining the original resource model of any target object in the original storage system comprises:
obtaining resource occupation information of the target object in the original storage system within a period of time; and
in response to the resource occupation information not comprising information triggering a system early warning, querying service operation data corresponding to the resource occupation information in a system log, and constructing the original resource model based on the resource occupation information and the service operation data.

3. The method according to claim 2, wherein the resource occupation information comprises: central processing unit (CPU) occupation information, disk read/write information, input/output (IO) delay information and/or memory occupation information.

4. The method according to claim 2, wherein obtaining the resource occupation information of the target object on the original storage system within the period of time comprises:
in response to the resource occupation information at any moment exceeding a preset value, recording the resource occupation information at a current moment; in response to the resource occupation information at any moment not exceeding the preset value, not recording the resource occupation information at the current moment and starting a countdown at the same time; and
in response to the resource occupation information exceeding the preset value before the countdown ends, forcibly ending the countdown and recording the resource occupation information exceeding the preset value at the same time; and in response to the resource occupation information never exceeding the preset value during the countdown, summarizing all recorded resource occupation information to obtain the resource occupation information within the period of time.

5. The method according to claim 2, further comprising:
in response to the resource occupation information comprising the information triggering the system early warning, dividing the resource occupation information into alarm information triggering the system early warning and non-alarm information not triggering the system early warning;
querying service operation data corresponding to the alarm information in the system log, and generating an alarm report based on the alarm information and the service operation data; and
querying service operation data corresponding to the non-alarm information in the system log, and constructing the original resource model based on the non-alarm information and the service operation data.

6. The method according to claim 1, wherein determining the software/hardware resource update strategy of the target object by comparing the original resource model with the target resource model comprises:
comparing the original resource model with the target resource model to obtain a comparison result; and
determining a software/hardware configuration to be updated for the target object based on the comparison result, and obtaining the software/hardware resource update strategy based on the software/hardware configuration.

7. The method according to claim 6, further comprising:
pre-constructing available model libraries corresponding to the application processes, the virtual machine kernels, and the file storage services respectively.

8. The method according to claim 7, wherein each of the available model libraries stores one or more target resource models which do not cause a sudden failure of a storage system or reduce a probability of the sudden failure of the storage system.

9. The method according to claim 8, wherein each of the target resource models has a corresponding attribute, and the corresponding attribute is the front-end service type.

10. The method according to claim 9, wherein the front-end service type comprises: an office service of office automation (OA), an e-commerce service, a financial service, or a customer service.

11. The method according to claim 1, further comprising:
determining an original service traffic model corresponding to the original resource model;
determining a target service traffic model corresponding to the target resource model; and
comprehensively determining the software/hardware resource update strategy by comparing the original resource model with the target resource model and comparing the original service traffic model with the target service traffic model.

12. The method according to claim 11, further comprising:
determining one or more traffic difference points by comparing a traffic curve of the original service traffic model with a traffic curve of the target service traffic model; and
determining the software/hardware resource update strategy according to the traffic difference points and a comparison result between the original resource model and the target resource model.

13. The method according to claim 12, wherein the software/hardware resource update strategy is configured to limit a processing speed of one or more non-instantaneous operations.

14. The method according to claim 2, wherein the original resource model of the target object is constructed based on the resource occupation information of the target object in the original storage system and the service operation data.

15. The method according to claim 14, wherein the resource occupation information and the service operation data used to construct the original resource model of the target object meet one or more operation requirements of a storage system, and represent a normal operation of the target object.

16. The method according to claim 1, wherein the original storage system is a storage system being used by an original service party.

17. The method according to claim 1, wherein the original storage system is another storage system of a same type as front-end services of a storage system being used by an original service party.

18. (canceled)

19. An electronic device, comprising:
a memory for storing a computer program; and
a processor for executing the computer program to implement the method according to claim 1.

20. A non-transitory computer-readable storage medium storing computer programs, wherein the computer programs, when executed by a processor, cause the processor to implement the method according to claim 1.

21. The method according to claim 14, wherein the service operation data is a reason for the appearance of the corresponding resource occupation information.
